(19) United States
(12) Patent Application Publication
(10) Pub. No.: US 2008/0282838 A1
(43) Pub. Date: Nov. 20, 2008

(54) Engine connecting rod for high performance applications and method of manufacture

(76) Inventor: Robert R. Weaver, Mooresville, NC (US)

Correspondence Address: Robert R. Weaver, 109 Courtney Lane, Mooresville, NC, 28117, US

(21) Appl. No.: 12/220,615

(22) Filed: Jul. 25, 2008

Related U.S. Application Data
(63) Continuation-in-part of application No. 11/064,588, filed on Feb. 23, 2005.
Application No. 11/064,588 is a continuation-in-part of application No. 10/079,150, filed on Feb. 20, 2002, now abandoned.
(60) Provisional application No. 60/270,279, filed on Feb. 22, 2001.

(51) Int. Cl. F16C 7/00

(52) U.S. Cl. 74/579 E

(57) ABSTRACT

An internal combustion engine connecting rod, having an embodiment defining a hollow beam member and a process of manufacture are disclosed. The improvement substantially reduces beam tensile and compressive stress levels through application of elliptical and convex segment profile beam sections, conserving reciprocating and rotating connecting rod weight required in high performance engine applications.

### CROSS-REFERENCE TO RELATED PATENT APPLICATIONS

This is a continuation-in-part of pending U.S. patent application Ser. No. 10/079,150 filed Feb. 20, 2002, titled Engine Connecting Rod for High Performance Applications and Method of Manufacture. The benefit of U.S. Provisional Patent Application Ser. No. 60/270,279, filed Feb. 22, 2001, is claimed.

### BACKGROUND OF THE INVENTION

1. Field of the Invention

The present invention relates to the field of high performance internal combustion engines pertaining to a connecting rod having a Hollow Beam construction providing a lighter and stronger connecting rod beam member, accomplished by originated elliptical type and eccentric circular segmented walled cross-sections.

2. Description of Background Information

Hollow connecting rods have a history dating back to early automotive engines of the 1920's. Particularly, achieving notoriety in high performance engines. In the mid 1960's the Meyer and Drake, “Offy” racing engines were phased out of use at the Indianapolis 500 mile races after over 20 years of reliable winning performance using hollow connecting rods. Since then, numerous patents have been awarded for hollow connecting rod inventions based on improvements to the original and basic features of historically known hollow beam connecting rods. Beam features such as a round hollow tube or having elongated tubular cross-sections and inserts to close the hollow beam cavity remain as the bases utilized for patented improvements.

In the field of hollow connecting rods patents generally are for beam inventions applied to casting processes and not specifically for high performance or racing. Hollow connecting rods having cast cylindrical tubular beam members being disclosed in, for example, U.S. Pat. No. 5,140,869 to Mrdjenovich, et al (1992). This invention, a casting disclosure for an original and improved hollow beam casting is based on known hollow beam elements.

Another invention for making a hollow beam member is based on having very wide spacing of the beam sides by means of longitudinal arc sides being tangent to piston pin bore and crankshaft bores (beam side being spaced each side of each bore). Including long cavity closing inserts extending between the longitudinal arc sides. U.S. Pat. No. 3,482,467 to Volkel (1969), the beam member is described and patented to have the side walls formed as a full arc inner surface “tangent” to bores of the piston pin (first bore) and the crank-shaft journal connection (second bore). This requires that the hollow cross-section major axis width be excessive creating a poor load force beam structure and that cavities be sealed with a very long insert at the crankshaft end that is without support to react high compressive peak forces; as high as 17,000 lbs. during the power stroke. A potential for bearing distress results due to the long unsupported span. The cavity closing insert being thin has potential for deflecting under power force. Deflecting only 0.002 inch will close bearing lubrication clearance, leading to failure. Volkel by patent claiming the inner wall “tangent” to the piston pin bore and outer wall “tangent” to outer wrist-pin boss diameter, and claming wall thickness between inner and outer arcs to be made large as possible at lower end adds wasted mass at the journal area beam sides, the wrong place for strength. Two conditions make Volkel's connecting rod unsuitable for high performance use and different then the present invention. (1) Volkel created a massive lower thick wall, making the rod heavier with mass questionably offset away from the force axis by the pronounced arc inner sidewalls “tangent” to both bores. The “tangent” sidewalls being ether side of the journal bore is alarming because the load force is directed in line with the longitudinal axis is not recognized, Also disturbing is the long sealing insert essentially is without bearing support structure. (2) Very thin wall sections at the wrist-pin boss and sharp corners invite high stress concentration areas. Stress concentrations are areas were stress forces collect due to material shape and mass affecting load path. Generally stress concentrations generate higher stress level values and problem areas. Volkel's invention is an investment casting. In order to be manufactured compromises with strength, mass and configured form were made. Volkel's invention disclosed a very different way to make a hollow beam noticeably different in form function and particularly in claims than the present invention disclosed herein.

Another invention improvement for making a hollow beam is also based on long recognized approaches, that being elongated cross-section, in direction of crankshaft rotation. Disclosed is a method to make the hollow beam cross-section by using formed thin sheet metal to close the hollow beam and cap cavities. U.S. Pat. No. 5,370,093 to Hayes (1994) requires fabrication from costly preformed sheet metal using multiple piece joined assembly. The multiples thin sheet metal walls, welded into an assembly have limited load capacity and stress distribution, not considered appropriate for high performance applications; where high strength alloy steel and forgings are an important requirement. This is another patent noticeably different in form function and particularly in claims than the present invention disclosed herein.

Reviewing the work of Volkel and Hayes and others, they do not address the objectives or distinctly disclose beam member elements and particularly elliptical profile specification of the present invention. This invention improvement discloses means for lowering stress level concentrations and improved force flux flow distribution from wrist-pin boss to crank-shaft boss. Disclosed is a unique minimal cross-sectional beam having elliptical form profiles providing area and mass improving compressive, tensile and eccentric force load capability over previous patented hollow connecting rods reviewed here, in archives and high performance connecting rods being manufactured.

### SUMMARY OF THE INVENTION

In one form of this invention there is provided a connecting rod for an internal combustion engine including a hollow beam member. The hollow beam connecting rod includes a piston pin bearing boss and crankshaft bearing boss elements. The boss elements are typical for high performance “racing” engine requirements that have configuration eliminating stress concentration, and providing force flux pathways to minimize stress levels and provision for high strength alloy steel, features generally lacking in prior art. The first end of the improved hollow beam member is joined to a high performance piston pin bearing boss element through a first curved region. The second end of the hollow beam member is joined to a high performance crankshaft bearing boss through a second curved region. The primary improvement is a hollow beam member formed by projected elliptical profile cross-sections on projection planes located at the beam member first end and the second end and centered on the longitudinal beam axis. The walls of the hollow beam member are defined preferably by elliptical outer and defined inner cross-section profiles inline, projecting direct “straight” beam walls from the first to the second elliptical cross-section projective plane. Avoiding the tangent beam sidewalls of Volkel. Sidewalls have a minimal required thickness and cross-section length increase in the major axis direction (direction of crankshaft rotation) than in the minor axis direction. Profiles embody a disclosed “ratio” system specifying wall thickness and profile cross-section major and minor axis length. In another form of the ellipse a “prolonged ellipse” also known as a “stretched ellipse” is provided by increasing the eccentricity (length) in the major axis.

In accordance with another form of the invention there is provided a hollow beam member having variant cross-section profiles. The connecting rod includes a piston pin bearing boss and a crankshaft bearing boss as previously described. The cross-section profile of the hollow beam member first end and the second end being convex-segment cross-section profiles. Disclosed as a closed plane of curved segments (fixed radius arc segments) joined, intersecting as disclosed herein. The hollow beam member walls are thicker and beam length longer in the major axis direction (in plane of crankshaft rotation) than in the minor axis direction. A ratio system specifies profiles wall thickness and beam width. In another form of the convex profile a “prolonged convex profile” is provided, also known as a “stretched convex profile” provided by increasing the eccentricity (length) in the major axis. In accordance with another form of this invention there is provided a hollow beam member cross-section profile first end and the second end outer profile being elliptical or convex cross-section profiles. The inner profile embodies a circular fixed radius arc bore.

The present invention provides a connecting rod comprising a hollow beam member of near minimum cross-section area and mass achievable. It is preferred that this is accomplished by precise beam wall cross-sections having elliptical or convex segment cross-section profile formation configured to a beam member column structure, having specific profile sidewall thickness and width ratios. The disclosed beam column form directs compressive and tensile forces centered about the longitudinal axis of load force path from piston pin to crankshaft journal, improving and “keeping the load path inline” and in-close proximity to the longitudinal axis. Thus efficiently distributing stress concentration throughout the connecting rod beam member. The embodiment potential is elimination or minimizing stress concentrations thus lowering high peak stress levels. Resulting in reliable performance at high engine RPM (Revolutions Per Minute) and improved fatigue life. This is important over prior art because weight reduction reduces mass inertia forces further lowering stress levels. Placement of beam defining cross-sections and section profile are defined with a ratio method to facilitate design and analysis of hollow beam connecting rod manufacturing. Materials, especially high strength alloy steel and forgings (180,000 to 220,000 psi) are “required” for the high performance engine connecting rod embodiments of the present invention. This requirement is not provided by noted prior art; being casting and sheet stock construction.

The primary objective of providing lower stress levels and lower reciprocating weight is to reduce inertia forces. Inertia forces affect engine performance and increase stress in connecting rods. Hollow rod beam weight reductions of 45 to 60 grams over competing solid beam connecting rods have occurred in designs disclosed herein. Reduction of 45 grams of reciprocating weight will reduce peak inertia force by about 400 pounds at peak RPM, determined in studies. Performance is improved by increasing compressive force by 400 pounds on the piston during the power stroke. This is possible because inertia force (400 lbs.) must be overcome during the early part of power stroke by combustion pressure to push the piston during the power stroke. Thus imparting 400 lbs. gain in force to crankshaft rotation, a performance gain provided over prior art.

Another objective is to provide an aerodynamic shape to reduce effects of rod contact with the ambient oil particle environment and air occurring within an engine at high RPM.

An improvement shown in one embodiment of this invention is a new connecting rod beam member cross-section being an ellipse form. The objective being accomplished by varying cross-section profile shape and directional dimensions to meet requirements of stress analysis facilitated by embodiment of a ratio system specifying beam wall thickness and beam section cross-section major axis length. The process provides cross-section being elliptical profiles and geometric convex-segment profiles on finite projection planes to form and project precise beam member column form.

An improvement of one embodiment of this invention is having a procedural embodiment to define and locate profile cross-section forms on projection planes centered on the beam longitudinal axis to project the connecting rod beam member surface form. A further purpose is to reduce the number of elements required to define a connecting rod beam to a few cross-section profiles, preferably two profiles placed on the beam longitudinal axis. The beam form disclosed using projection planes particularly facilitates connecting rod design using computer programs. This objective simplifies and facilitates accurate and analyzed connecting rod design. Computer programs which may be used are Computer Aided Design (CAD), Finite Element Analysis (FEA) and Computer Numerical Controlled (CNC) machining. Another advantage of the improvements disclosed and claimed herein is facilitated design and files computer generated and transferred by electronic means such as E-mail directly to CNC manufacturing machines and facilities.

An advantage of this invention is the embodiments are applicable for casting manufacturing processes for conventional connecting rods using the teachings of the present invention. Beam member wall thickness and dimensions being adjusted for casting material strength being the change.

An improvement shown in one embodiment of this invention is having a reliable connecting rod oil transfer tube from the crankshaft region to the piston pin bore. Beam movement and deflections would stress a rigidly fixed oil transfer tube installation of prior art. The oil tube shown provides a transfer tube that is compliant to bending, flexing, and to the tensile or compressive dynamic engine forces. The oil tube compliance is accomplished by an improved beam cavity sealing closure tapered plug that provides a recess accommodating O-Ring seals. The tube is sealed from leakage and remains compliant to movement forces at the O-ring connection. The upper end, being secured fixed to the piston pin boss. The tube is an optional provision and is not required or used in all applications.

An improvement of one embodiment of this invention is a new application to provide a connecting rod bearing cap alignment embodiment to provide a more rigid alignment connection. This may be accomplished by machined sleeves, circular extending above the connecting rod cap surface and extending around the cap connection bolts. The sleeves register into mating bored recesses in the rod journal connection providing an accurate fitting cap to rod assembly. Previous sleeves in common use being separate elements pressed into the bearing cap, resulting in the cap being bored for sleeve installation weakening the structure and being compliant, not a rigid connection.

Other objectives and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include the embodiment of this invention.

FIG. 1 is a front elevation view of a connecting rod assembly illustrating one embodiment of the connecting rod of the present invention.

FIG. 2 is a side elevation view of the connecting rod of one embodiment of the present invention.

FIG. 3 is a longitudinal section view of the connecting rod of one embodiment of the present invention taken along the cut line 3-3 of FIG. 2.

FIG. 4 is a transverse sectional projection plane view of the connecting rod of one embodiment of the present invention taken along the cut line 4-4 of FIG. 1.

FIG. 5 is a transverse sectional projection plane view of the connecting rod of one embodiment of the present invention taken along the cut line 5-5 of FIG. 1.

FIG. 6 is a front elevation view of the connecting rod assembly of another embodiment of the present invention for purpose of illustrating transverse sections having prolonged ellipse plane form.

FIG. 7 is a transverse section view of ellipse profile application to FIG. 6 before being prolonged.

FIG. 8 is a transverse section projection plane view of the connecting rod of FIG. 6 taken along the cut line 8-8 of FIG. 6.

FIG. 9 is a transverse section projection plane view of the connecting rod of FIG. 6 taken along the cut line 9-9 of FIG. 6.

FIG. 10 is a front elevation view of the connecting rod assembly of another embodiment of the present invention for purpose of illustrating transverse section having convex-segment profile form.

FIG. 11 is a transverse projection plane view of the convex-segment profile of FIG. 10 taken along cut line 11-11 of FIG. 10.

FIG. 12 is a transverse projection plane view of the convex-segment profile of FIG. 10 taken along cut line 12-12 of FIG. 10.

FIG. 13A is a front elevation view of the connecting rod assembly of another embodiment of the present invention for purpose of illustrating transverse section having ellipse outer profile form and radial circular inner centered bore. FIG. 13B is a side elevation view of FIG. 13A illustrating partial view of inner profile form.

FIG. 14 is a transverse projection plane view of the ellipse outer and radial inner profile of FIGS. 13A and 13B taken along cut line 14-14 of FIG. 13A.

FIG. 15 is a transverse projection plane view of the ellipse outer and radial inner profile of FIGS. 13A and 13B taken along cut line 15-15 of FIG. 13A.

FIG. 16 is a partial front elevation view of the connecting rod view FIG. 1 illustrating cavity closure plug.

FIG. 17 is a plane and side view of cavity closure plug from view FIG. 16.

FIG. 18 is a partial front elevation view of the connecting rod view FIG. 13A illustrating cavity closure plug.

FIG. 19 is a plane and side view of cavity closure plug from view FIG. 18.

FIG. 20 is a graphic illustration designation of the ellipse profile geometry defining one form of the present invention.

FIG. 21 is a graphic illustration designation of a two segment radius convex-segment profile geometry defining one form of the present invention.

FIG. 22 is a graphic illustration designation of a three segment radius convex-segment profile geometry defining one form of the present invention.

RATIO TABLE 1: “Ratios for wall thickness and profile length at second cross-section, major axis”.

### DETAILED DESCRIPTION OF THE INVENTION

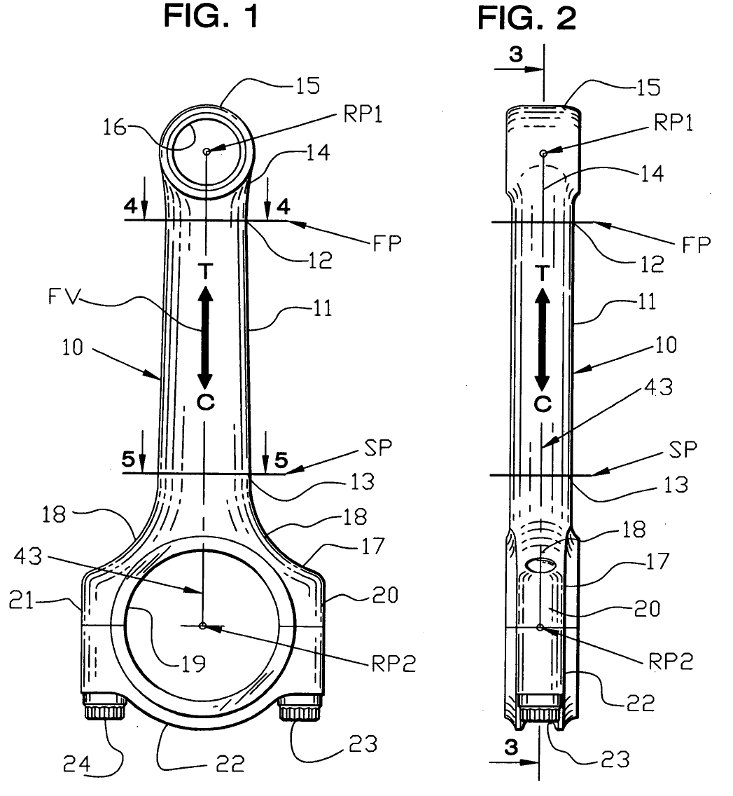

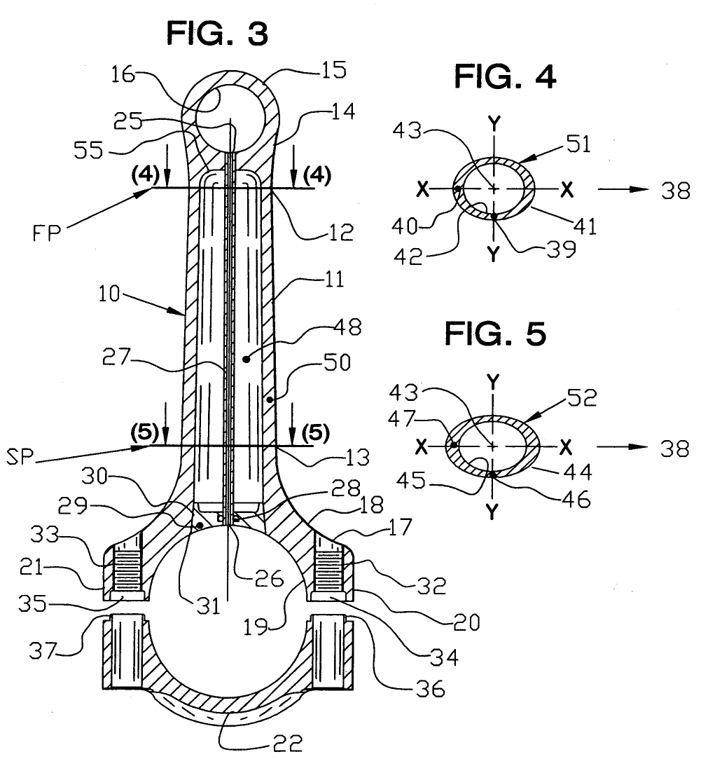

A general portrayal of disclosed hollow connecting rod embodiments being presented that are applicable to FIG'S. 1, 6, 10 and 13. With reference to FIG. 1 and FIG. 2 of the drawings there depicted a hollow connecting rod 10 for use in high performance engines. The connecting rod 10 comprising an elongate longitudinal column beam member 11 having two opposite ends 12, 13 each forming a one-piece beam segment. There merging from first end 12 are arcuate side surface 14 flanks, joining piston pin bearing boss 15 having a round bearing surface 16, for cooperating with a piston pin (not shown). At beam member 11 the opposite second end 13 is a crankshaft bearing boss 17, having arcuate side surface 18 flanks, including a round bearing surface 19 for cooperating with a bearing insert and crankshaft journal when secured thereto (not shown). Crankshaft bearing boss 17 having bolt boss 20, 21, secured thereto bearing cap 22 by bolts 23, 24. As noted in FIG. 1, hollow beam member 11 employs a system of cross-sections; consisting of cut lines 4-4 and 5-5 including a first cross-section projection plane FP and second cross-section projection plane SP on which cross-section profiles that define the hollow beam member 11 are originated. Beam member 11 is projected between the originated cross-section profiles created on the cross-section projection planes FP and SP. Each cross-section is centered on connecting rod longitudinal axis 43. The beam member 11 form is projected from a first cross-section profile 51 to a second cross-section profile 52, illustrated by FIGS. 4 and 5, The projected cross-section profiles 51 to 62 produce a beam member 11 having a straight line sidewall 50. Preferably only two cross-section projection planes are required. Further details of profiles being disclosed after completing disclosure of FIG. 3 inner structure embodiments that follows.

Beam member 11 column Inner structure description being presented, with reference to FIG. 2, a longitudinal section view is taken along cut line 3-3 to disclose the inner structure of the connecting rod of this invention, best shown in FIG. 3 as follows. The piston pin bearing boss 15 provides an optional oil passage tube 27 embodiment consisting a first passage 25 which extends longitudinal on axis 43 with respect to the beam member 11 to the round piston pin bearing surface 16. Viewing the opposite end, within the crankshaft bearing boss 17 is a second passage 26, extending to the round bearing surface 19. Continuing with FIG. 3 thereto passage 25 and 26 is secured oil passage tube 27 for the purpose of transferring oil from second passage 26 to first passage 25. Oil passages tube 27 being fixed and secured at first passage 25. Oil passage tube 27 being sealed at second passage 26 thereby a unique Oil packing seal 28 embodiment providing for axial motion differential between oil passage tube 27 and the connecting beam member body, thereto eliminate interacting movement between beam member 11 and oil passage tube 27. Oil passage tube 27 assembly embodiment is an optional feature required for certain applications.

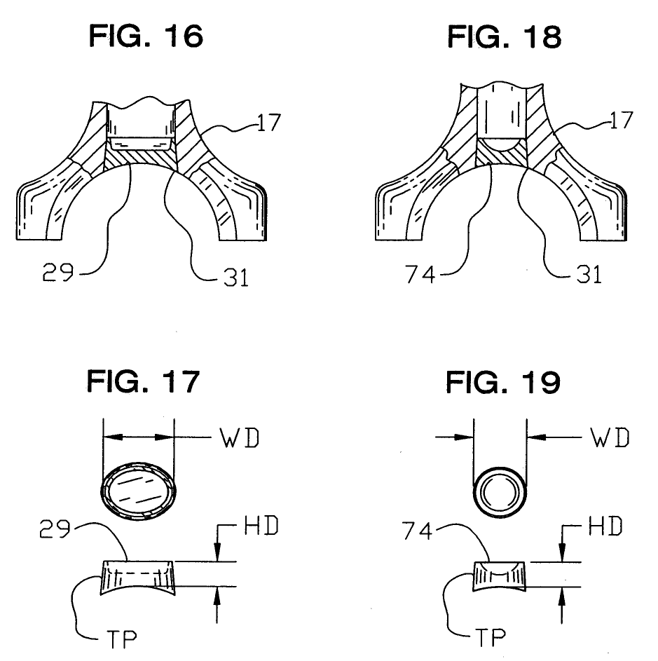

Inner beam elements at crankshaft connection being continued. Referring to FIG. 3, the elongate hollow beam member 11 there being hollow cavity 48 with wall 50 having cross-section inner profiles 42 and 45 (FIGS. 4 and 5) projected from first cross-section projection plane FP profile to second cross-section projection plane SP, defining hollow cavity 48, sidewall 50. Cavity 48 ends approximately 0.150 inch above first projection plane FP having substantial end radius 55. This is a specific embodiment required to avoid any sharp corners or edges that concentrate stress leading to fatigue cracking. Now continuing in FIG. 3, the cavity 48 of connecting rod member 11 there being an closure tapered plug 29 embodiment fitted to tapered beam wall 30 for the purpose of sealing beam cavity 48. The closure tapered plug 29 having partial thin wall, a compliant segment to relieve compressive pressure force at closure tapered plug 29 outer edge. The closure tapered plug 29 is bonded or fusion welded 31 in place. Turning to FIG. 16 and FIG. 17 illustrating a partial view of crankshaft bearing boss 17 and closure tapered plug 29 embodiment; having a preferred taper TP of 3 to 5 degrees. A predetermined depth HD ratio sized to eliminate deflection issues for hollow connecting rod configurations herein; depth ratio HD preferred to be 35% to 50% the width WD of closure tapered plug 29. Illustrated is a ratio of 36%. The disclosed purpose of the taper is to direct axial force on closure tapered plug 29 by tapered “wedging” that force into side walls of crankshaft bearing boss 17, eliminating deflection at closure tapered plug 29; which is a problem with noted prior art. With reference to FIG. 1, the bolts 23, 24 extend through bolt boss 20 and 21 from bearing cap 22 into threaded bores. Returning to FIG. 3, threaded bores 32 and 33 are illustrated. The bolts 23, 24 have been omitted from FIG. 3 for clarity to disclose the embodiment whereby bearing cap 22 assembles and therein is aligned to crankshaft bearing boss 17 as follows. Alignment receptacle 34 and 35 are circular machined into bolt boss 20 and 21 concentric with bolt and thread axis having a depth to accept matching extended machined circular alignment sleeves 36 and 37 machined onto the mating surface of the bearing cap 22. Note that FIG. 3 illustrates cut lines from FIG. 1 in parentheses. The purpose is to indicate facilitating reference when viewing content of FIG. 3 related to cut lines (4)-(4) and (5)-(5).

Prior to continuing with profile description, the tensile and compressive force conditions improved by the hollow beam connecting rod beam structure is described. Referring to FIG. 1, tensile and compressive force conditions are described that are provided for by the invention embodiments. Note center longitudinal axis 43 between first reference point, RP1 and second reference point RP2; indicating the linear tensile T force and compressive C force. Vector FV represents force action on disclosed connecting rod structure. Tensile force T results from piston and piston pin inertia mass effect on the piston assembly upward movement. Compressive force C results from combustion force of the power stroke on the piston assembly downward movement. Tensile (inertia force) force of 7,200 lbs. and compressive force of 17,100 lbs. react to piston pin bearing surface 16 and bearing surface 19 through column beam member 11 at reference points RP1 and RP2, are typical force examples. Hollow rod beam member 11 embodiments provide a preferred column structure having cooperating straight sidewall 50, aligned under and line with piston pin boss 15, remaining in close proximity with the noted axial force vector FV being collinear with longitudinal axis 43.

Continuing disclosure of elliptical cross-section profile embodiment for beam member 11 being presented. The profile development means defining profiles and alignment that follows is applicable to other beam member 11 embodiments disclosed herein. Cut-lines 4-4 and 5-5 therein indicating cross-section locations. Illustrated in FIG. 4, the first cross-section profile 51 and FIG. 5 the second cross-section profile 52. The beam member profile cross-section and positioning feature of this invention there being disclosed, beginning with FIG. 4, the first cross-section profile 51 axis convention being disclosed; beginning with axis X-X of first cross-section profile 51, the axis X-X is in the direction of crankshaft plane of rotation 38 and is the major (long) axis of cross-section profile 51. Axis Y-Y is in the direction normal to crankshaft rotation and is the minor (short) axis of cross-section profile 51. FIG. 5 identifies the second cross-section profile 52. Note axis X-X is defined as the major axis and axis Y-Y is defined as the minor axis. Both cross-section profiles 51 and 52 are centered on longitudinal axis 43.

First cross-section profile 51 and second cross-section profile 52 formations being disclosed. Returning to FIG. 4, illustrating first cross-section profile 51. Elliptical type outer profile 41 and inner profile 42 define the beam member 11 and sidewall 50 thickness at first cross-section profile 51. Specified wall thickness 39 indicated on the minor Y-Y axis and specified wall thickness 40 on major axis X-X. Note that wall thickness increases, beginning from the minor axis Y-Y at thickness 39 changing gradually to the major axis X-X at thickness 40.

Continuing now with the second cross-section profile 52, referring to FIG. 5 location of second cross-section profile 52 elliptical type having outer profile 44 and inner profile 45 defining beam member 11 and sidewall 50 thickness at cross-section profile 52. Sidewall thickness 46 being on the minor Y-Y axis and wall thickness 47 being on major axis X-X. Illustrating longer outer profile 44 X-X length and increased wall thickness 47 than first cross-section 51, wall thickness 40 on the major axis profile. The longer major axis and increased sidewall thickness 47 being required accommodating higher bending moments occurring in second cross-section profile 52 area, plane of crank-shaft rotation. Cross-section profiles 51 to 52 projected sidewall thickness and beam length in the X-X and Y-Y axis are defined embodying “ratios” of cross-section profiles 51 and 52, to follow.

Embodiment to establish cross-section profile sidewall 50 thickness and beam X-X and Y-Y length being provided by means of “ratios” that optimize efficient beam member 11 column structure for close inline support of noted direct acting force vector FV, tensile force T and compressive force C. A convenient control system employing a first “ratio” multiple of first ellipse cross-section profile 51 sidewall thickness 39 and 40 defining second profile 52 sidewall thickness 46 and 47. And, a second “ratio” multiple of first ellipse 51 major and minor axis length defining second profile 52 major and minor axis length. Ratios are derived from analysis of connecting rod designs conforming to the present invention embodiments.

Ratio application method disclosed as follows is applicable to beam member 11 of FIG'S. 1, 6, 10 and 13. The ratio application is illustrated in FIG'S. 4 and 5. Wherein the second cross-section profile 52, profile major axis thickness 47 is derived by multiplying first cross-section profile 51, sidewall thickness 40 by a first ratio range of 1.00 (being a ratio of 1 to 1) to 5.00 (being a ratio of 5 to 1). And, second cross-section profile 52, major axis length derived by multiplying cross-section profile 51 major axis length by a second ratio range of 1.00 (being a ratio of 1 to 1) to 1.50 (being a ratio of 1.50 to 1). Preferably the ratios for profile sidewall thickness 39 and 46 and length of cross-section profiles 51 and 52 is 1 to 1 in the minor axis, as illustrated, to accommodate design and manufacturing simplicity. Referring to Table 1, “Ratios for wall thickness and profile length at second cross-section, major axis” provides ratio application instruction to the preferred second cross-section major axis profile dimension requirements. And, is applicable to all hollow connecting rod beam member 11 herein. The minor axis profile thickness and length has a preferred ratio of 1 to 1.

Continuing with disclosure of the elliptical form profile embodiment. The descriptive ellipse example disclosed herein being determined using the mathematical “Equation of the Ellipse”, as used in Analytical Geometry. Variations of the ellipse equation may be used to alter the radius of curvature and the cross-section elliptical profile to distribute mass to optimize the beam member stress levels and load efficiency. By example, FIG. 4 the length dimension of the minor axis Y-Y may be significantly reduced making the beam cross-section with less length in the Y-Y direction, or the ellipse profile defined as a “flattened circle” as described in Mark's, Mechanical Engineering Handbook. Further stating, the ellipse may be “stretched” geometrically known in geometry as a “prolonged ellipse” on the major axis X-X.

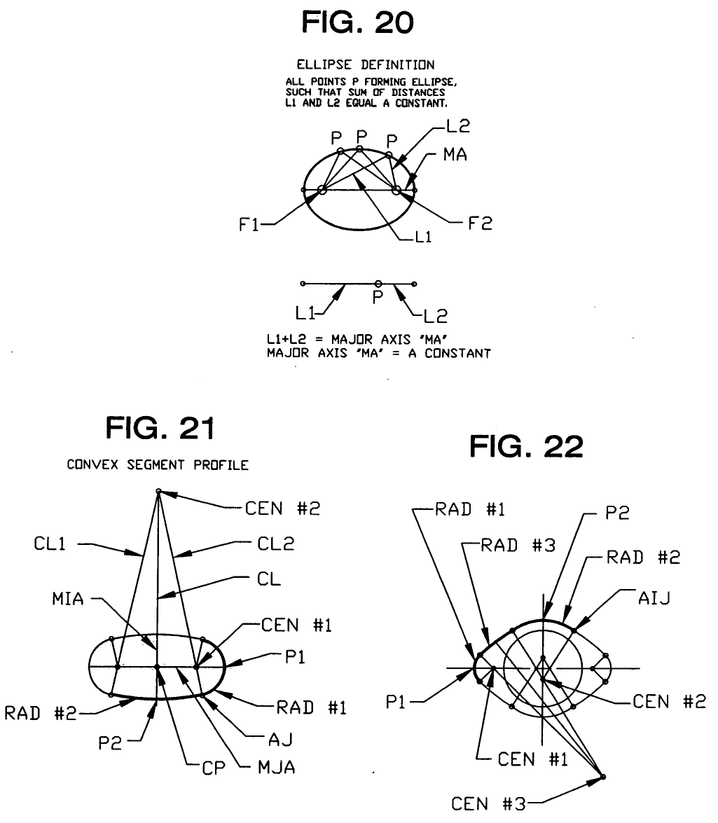

Formulas for ellipses may be found in mechanical engineering handbooks. Mechanical Engineers' Handbook by Lionel S. Marks in general use provides formulas to develop various elliptical constructions applicable to this invention. The preferred method for ellipse form cross-sections development is the use of Computer Aided Design, CAD programs, creating an ellipse having the “Equation of the Ellipse” is simplified using CAD programs. These programs require input of only the major axis and the minor axis length dimensions. The program “Ellipse Icon” draw command then automatically constructs the ellipse effortlessly using “Equation of the Ellipse” as illustrated in FIG. 4 and FIG. 5. Referring to FIG. 20, the ellipse geometric representation of the algebraic equation for the ellipse definition embodiment of the present invention is illustrated. Points P enclosed in a projective plane form the ellipse profile; such that the sum of the distances from two fixed “focus” F1 and F2 to a point P is a constant. The embodiment defines the major axis MA length as the constant.

Continuing with disclosure of the cross-section profile embodiment improvement by a “second means” of construction for beam member 11. A preferred method improves the elliptical profile strength in the X-X direction by a slight profile distance length increase of mass placement at the major axis end; “stretching the X-X profile slightly for certain preferred applications.

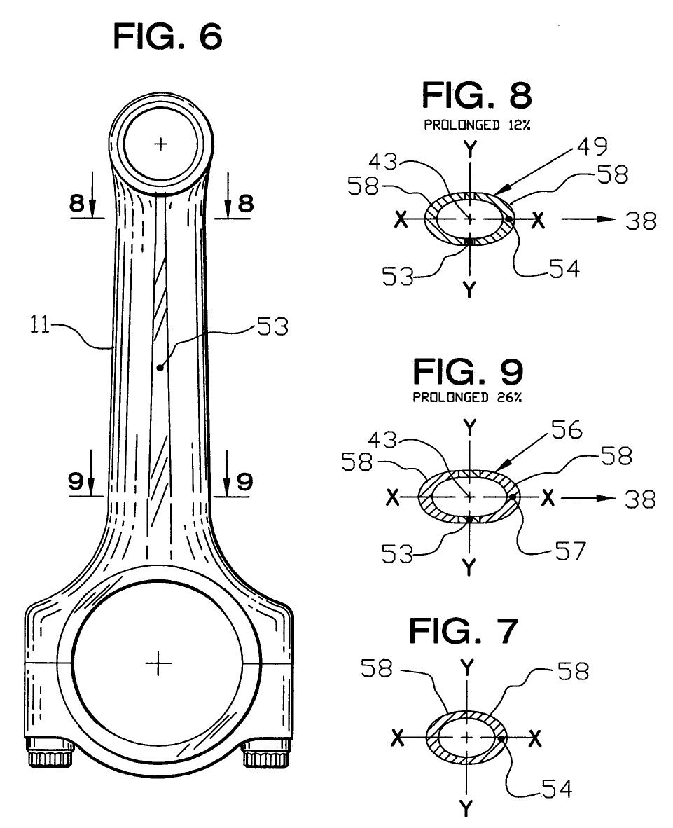

Continuing with FIG. 6 disclosing “second means” construction for beam member 11 having a cross-section elliptical profile stretched in the major axis and known as a “prolonged ellipse”. Certain high performance engines require more mass at the ends of a longer X-X major axis for strength. The “second means” is a preferred improvement to the ellipse profile disclosed by FIGS. 4 and 5; providing means to narrow the minor axis and increase the major axis length. The ellipse improvement is provided being “stretched”, known by the geometry term as a “prolonged ellipse”. Defined by wikipedia.org encyclopedia: “An ellipse may be uniformly stretched along any axis, in or out of the plane of the ellipse, and it will still be an ellipse”. Beginning with FIG. 7, disclosure of a true ellipse, having uniform ellipse section 58 each side of axis Y-Y, centered on axis X-X, is illustrated before stretching into a prolonged ellipse. FIG. 8 illustrates the first cross-section prolonged ellipse 49 profile taken at cut lines 8-8. Depicted stretched into a prolonged ellipse having a predetermined increased major axis length at profile sidewall segment 53 and increased sidewall thickness 54. By example, the FIG. 7 ellipse is uniformly stretched 12% into the prolonged ellipse 49 of FIG. 8. Profile sidewall segment 53, being centered on axis Y-Y.

FIG. 9, continues disclosing “second means” disclosing the second cross-section prolonged ellipse 56 profile taken at cut lines 9-9 illustrate ellipse by example uniformly stretched 26% at sidewall segment 53 bring centered on axis Y-Y. Embodiment of ratios previously used to define beam member 11 are used to prescribe second cross-section sidewall thickness 57 and major axis profile 56 beam length. Referring to “Ratio Table 1” application of ratios for sidewall thickness and profile length at second cross-section, major axis is disclosed for “second means”. The method used to determine first and second cross-section length dimension is preferred accomplished using FEA analysis to evaluate stress levels, patterns and stress concentrations, then making dimensional adjustment to define desired stress levels.

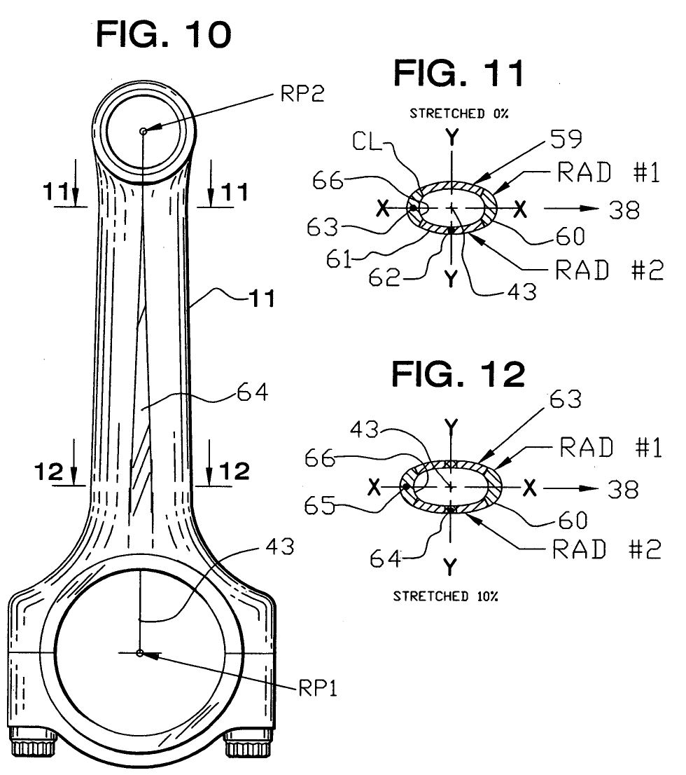

Continuing with FIG'S. 10, 11 and 12 disclosing “third means” construction for beam member 11 having a first “convex-segment” profile 59 and second prolonged convex-segment second profile 63 embodying axis alignment convention disclosed by FIGS. 1 and 6 for elliptical and prolonged ellipse cross-section profiles. Beginning with FIG. 10 disclosure of the convex-segment beam profile embodiment is illustrated. Cut line 11-11 is first cross-section having first convex-segment profile 59 at FIG. 11. Convex-segment profile is a geometric construction embodiment developed to employ two intersecting radius elements for profile construction; a first radius for the minor axis Y-Y profile and a second radius for the major axis X-X profile. RAD #1 is the first radius originating on each major axis end selected for the outer profile 60 major axis. RAD #2 is the second radius originating on each minor axis end selected for the outer profile 61 minor axis. Construction of convex arc segments (RAD #1 and RAD #2) intersecting typical at CL positions; forming first convex-segment profile. The inner profile 66 is constructed as the outer profile providing required wall thickness 62 and 63

Continuing with FIG. 12, the second cross-section convex-segment profile taken at cut lines 12-12 illustrates a prolonged convex-segment profile 63 produced by uniformly stretched major axis X-X of FIG. 11 profile 59. Increasing profile 59 major axis length by a ratio range of 1.00 to 1.50. Illustrated profile 63 having beam major axis length ratio 1.10, by example, resulting in 10% prolonged convex-segment profile 63, and having centered segment 64 on axis Y-Y. The inner profile is constructed as the outer profile, except wall thickness 65 is established by Ratio Table 1. Prolonged centered segment 64 has preferred same thickness as wall thickness 62. The illustrated second prolonged convex-segment profile 63 is dimensioned using ratios. Referring to “Ratio Table 1” application of ratios for wall thickness and profile length at second cross-section, major axis is disclosed for “third means”. FIG. 12 illustrates wall thickness 65=ratio 1.11. Profile 63 major axis length=ratio 1.10.

Referring to FIG. 21, a geometric construction of the convex-segment profile definition of the present invention is illustrated. Consisting of two radius arcs, RAD #1 one at each side center point CP on major axis MJA, at opposite points P1 and RAD #2 one each side of center point CP on minor axis MIA, at opposite points P2. Arc centers CEN #1 is positioned on the major axis MJA, providing arc RAD #1 at each P1. Arc RAD #2 is positioned from point P2 on minor axis MIA, extending through center point CP to pivot center CEN #2 by construction line CL. The radii RAD #2 from CEN #2 intersect RAD #1 P1 at each arc joint AJ by construction lines CL1 and CL2. The embodied procedure improves arc intersection symmetry.

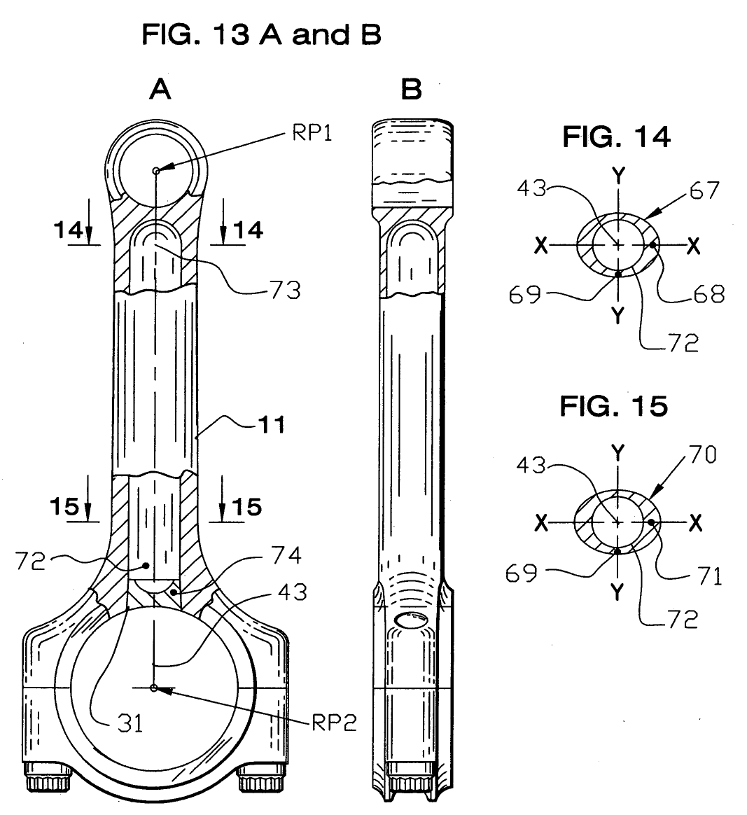

Continuing with FIG. 13 A an B partial section views disclosing a “fourth” improvement defining beam member 11 embodying elliptical outer beam profile and providing inner profile 72 consisting a circular fixed radius arc inner bore. Beam member 11 outer profile is projected from projection plane cross-sections at cut lines 14-14 to 15-15 centered on longitudinal axis 43. FIG. 14 taken at cut lines 14-14 define beam member first cross-section elliptical outer profile 67 having wall thickness 68 on the major axis and wall thickness 69 on the minor axis. FIG. 15 taken at cut lines 15-15 define second beam member 11 cross-section elliptical outer profile 70 having thickness 71 on the major axis and wall thickness 69 on the minor axis. Profile 67 and 70 wall thickness 69 are preferably equal. Ratios previously noted are applied to profile 67. Referring to “Ratio Table 1” application of ratios for wall thickness and profile length at second cross-section, major axis is disclosed for “forth means”. Inner bore 72 ends above cut line 14-14 and is required to have large radius, preferably a full radius as shown at radius 73.

Continuing at FIG. 13A, the partial section view discloses closure tapered plug 74, a circular tapered plug cooperating with profile of the open cavity, bonded or fused 31 in place. Plug tapers preferred at 3-5 degrees distributing compressive forces wedging and distributing into the heavier crankshaft bearing boss 17. Turning to FIG. 18, illustrated is a partial view of installed closure tapered plug 74 and separate view FIG. 19. A predetermined depth HD ratio sized to provide deflection resistance being disclosed. Depth HD preferred to be 35% to 50% the width WD of closure tapered plug 74. Illustrated is a ratio of 48%. The disclosed purpose of the taper is to direct axial force on closure tapered plug 74 by “wedging” that force into side walls of crankshaft bearing boss 17 to eliminate force deflection at plug 74.

Referring to FIG. 22 illustrated is a beam member 11 geometric cross-section profile embodiment provided for certain applications. Consisting of a convex-segment profile having 3 intersecting radius arc segments used to create a closed profile, preferably for outer cross-section profiles. The outer profile for beam member 11 of FIGS. 13A and B is an alternative preferred application for 3 intersecting radii convex-segmented outer profile; being illustrated in FIG. 22. RAD #1 is an arc radius at each end length of major axis X-X. RAD #2 is a arc radius at each end length of minor axis Y-Y. Arc center CEN #1 is positioned on the major axis providing an arc having RAD #1 at opposite points P1. And RAD #2 is positioned on minor axis providing an arc having RAD #2 at opposite points P2. Arc center CEN #2 is positioned on minor axis providing arc RAD #2 at opposite points P2. RAD #3 intersects RAD #1 to RAD #2 from CEN #3. CEN #3 being located by construction lines projected from end of arc intersecting segments AIJ through CEN #1 and CEN #2, projecting and terminating at intersection CEN #3, providing RAD #3 construction. The construction of intersecting arcs embodiment herein provides a preferable cross-section profile for certain applications, such as FIGS. 13 A and B. RAD #3 intersections are very close using the disclosed method, however not precise. Improved may be made by slight adjustment to CEN #3

The present invention embodiments consider use of computer programs to facilitate design of connecting rods using Computer Aided Design, CAD, in particular, 3 Dimensional, or 3D CAD programs and Finite Element Analysis, FEA. Connecting Rod cross-sections such as ellipses, elliptical forms can be generated using capabilities of CAD programs to facilitate cross-section profile development to accomplish connecting rod design of the present invention.

The connecting rod of the present invention embodiments having profile form and ratios controlling beam member form is particularly suitable of being manufactured using aluminum connecting rods such as used in drag racing. Applying “ratios” for beam member as disclosed herein and adjusted for material tensile strength and characteristics is required. The herein embodied disclosure being fully applicable to aluminum connecting rods. Investment casting, powder forging or conventional casting procedures are applicable to the disclosed embodiments. As best seen in FIG. 3 of this disclosure thereby illustrating that the connecting rod of this invention provides casting form, having capable casting draft in the Y-Y minor axis direction and casting parting lines through the X-X major axis.

The hollow beam connecting rod being a “Closed Beam” hollow column is capable of higher load capacity over conventional “Open Beam” columns. Most conventional high performance connecting rods are H-Beam configuration, having open flanges in direction of crankshaft rotation. Mass is centered on the longitudinal and neutral axis, requiring more mass to accommodate column and bending loads. The H-Beam open flange edges are affected with stress concentrations. The hollow “Closed Beam” embodiment herein places mass a defined distance from the longitudinal and neutral axis, less material is required to accommodate column and bending loads. And, there are no free standing open edges. Reducing beam mass results in less reciprocating mass being accelerated by inertia forces at high engine speeds. The Engineering method used regarding the present invention is a proprietary developed process designed to be simple, being based on experience and assembled study and analysis data. Programs where engine dimensions and data, RPM and component weights are entered determine the force loads acting on the connecting rod and beam as the crankshaft rotates through an engine cycle. Primary forces determined are (1) Tensile loads including peak tensile load. (2) Compressive loads including peak load. (3) Bending force and related angles. A preferred method used to determine the value for noted “ratios” applied to disclosed cross-section profiles is to relate determined cross-section “moments of inertia” and “cross-section area” to a ratio range. Providing the highest moments of inertia in the X-X major axis being the objective for a ratio range.

RATIO TABLE 1
RATIOS FOR WALL THICKNESS AND PROFILE LENGTH
AT SECOND CROSS-SECTION, MAJOR AXIS
First cross-section (upper) notation:

| | |
|---|---|
| Major axis sidewall thickness (W1) | Minor axis sidewall thickness (W2) |
| Major axis profile length (L1), | Minor axis profile length (L2) |

Second cross-section (lower) notation:

| | |
|---|---|
| Major axis sidewall thickness (W3), | Minor axis sidewall thickness (W4) |
| Major axis profile length (L3), | Minor axis profile length (L4) |

Second cross-section sidewall major axis thickness ratio:

Sidewall thickness major axis ratio (STR) range = 1.00 (being ratio 1 to 1)
to ratio 5.00 (being ratio 5 to 1)

Second cross-section major axis profile length ratio:

Major axis profile length ratio (PLR) range = 1.00 (being ratio 1 to 1)
to ratio 1.50 (being ratio 1.50 to 1)

Ratio Application Example:

First major axis sidewall thickness W1 = 0.122 inch.
Ratio STR applied = 1.29
Second major axis sidewall thickness W3 = 0.122 * 1.29 = 0.157 inch
Second major axis sidewall thickness increased to = 0.157 inch
First major axis profile length L1 = 0.962 inch
Ratio PLR applied = 1.155
Second major axis profile length L3 = 0.962 * 1.155 inch = 1.111 inch
Second major axis profile length increased to = 1.111 inch

What is claimed is:

1. An engine connecting rod having elliptical formed hollow beam member joined to a piston pin bearing boss at first end and joined to a parallel crankshaft bearing boss at opposite second end joined thereto by arcuate side surface flanks to piston pin bearing boss and to bolt bosses located each side of the crankshaft bearing boss there to connect with a connecting rod bearing cap member, comprising:
a beam member being hollow, having outer and inner surface being a elliptical profile form, having elliptical form cross-section profiles, dispersed longitudinally on cross-section projection planes being normal to and centered on connecting rod longitudinal axis; said elliptical cross-section profiles having a major (long) axis being in direction of crankshaft plane of rotation and a minor (short) axis being normal to crankshaft plane of rotation; said beam member having at least two said elliptical cross-section profiles centered on said longitudinal axis defining said hollow beam member outer and inner sidewall surfaces; including a (upper) first cross-section projection plane, and a (lower) second cross-section projection plane intersecting normal to said beam longitudinal axis; providing plainer location for a first elliptical cross-section profile joining into said piston pin bearing boss and a (lower) second elliptical cross-section profile joining into said crankshaft bearing boss;
said beam member outer sidewall surface being defined by a longitudinal surface straight line projection between said first and second outer elliptical cross-section profiles; Said internal surface, wall thickness and internal cavity sidewall surface therein defined by a longitudinal said beam member surface straight line projection between said first and second inner elliptical cross-section profiles; said first outer and inner profiles thereby being on said first cross-section projection plane, said second outer and inner profiles thereby being on said second cross-section projection plane;
said upper first cross-section projection plane and said lower second cross-section projection plane intersecting said beam longitudinal axis providing location for said first and second cross-section profiles; whereby arcuate side surface merge from hollow beam member first cross-section profile, merging into said piston pin bearing boss and said second cross-section profile thereto merging into said crankshaft bearing boss;
said first cross-section profile having said major and minor axis sidewall thickness and said profile axis length dimensioned to accommodate beam member maximum stress from combinations of axial and bending loads; said lower second cross-section profile having said major and minor axis profile sidewall thickness and said major and minor axis profile lengths being a ratio multiple of said first cross-section major and minor axis profile sidewall thickness and profile lengths;
said second cross-section profile sidewall thickness ratio multiple having said minor axis cross-section sidewall thickness being preferably a multiplication ratio of 1 that of said first cross-section sidewall minor axis thickness; said second major axis cross-section profile sidewall thickness being preferably a multiplication ratio of 1 to 5 that of first cross-section profile major axis sidewall thickness; said second cross-section profile minor axis length ratio multiple being preferably a multiplication ratio of 1 that of said first cross-section profile minor axis length; said second cross-section profile major axis length being preferably a multiplication ratio of 1 to 1.50 that of said first cross-section profile major axis length;
said inner profile open end being closed by a closure tapered plug having a 3 to 5 degree taper and matching beam closure opening; said closure tapered plug being bonded or fused in place. Said closure tapered plug having a predetermined opening closure depth ratio; said depth ratio to be 35% to 50% the width of said closure tapered plug.

2. The connecting rod of claim 1, wherein said hollow beam member, said first and second cross-section projection planes having said elliptical cross-section profiles being prolonged (stretched) in said major axis direction; said prolonged ellipse geometrically constructed from said ellipse of claim 1 by extending uniformly from each side of the minor axis intersection, increasing said prolonged ellipse length in the major axis direction;
Said second cross-section prolonged ellipse having said major and minor axis wall thickness and axis length wherein said sidewall thickness of said second cross-section profile being a multiplication ratio; said second cross-section profile said major and minor axis profile length being a multiplication ratio; said multiplication ratios being that of claim 1.

3. The connecting rod of claim 1, wherein said hollow beam member first and second cross-section projection planes having a convex-segment profile of geometric construction; said convex-segment profile consisting of two predetermined radii arc angles; a first radius arc angle, one each at opposite ends of said convex-segment profile major axis, having said first radius arc center positioned on said major axis at each major axis end;
a second radius arc angle, one each at opposite ends of said convex-segment profile minor axis; said second radius arc center positioned by construction lines; having a first center construction line collinear to said minor axis, intersecting a profile reference center point, said reference center point being intersection of said major and said minor axis; having a first and second construction line each projecting from said first radius arc end point of each said first radius arc; said construction lines project and intersecting through each first radius arc centers, continuing projecting said construction lines to intersecting said first center construction line, establishing second radius arc center; thereto defining said second arc center position being the origin for said second arc intercepting each first arc radius at each construction line and arc intersection; said second radius arc intercepting each first radius arc at constriction lines.

4. The connecting rod of claim 1, wherein said hollow beam member cross-sections being a elliptical outer profile and a circular radius arc longitudinal inner profile; having claim 1 ratios using first cross-section dimensions to define major and minor second cross-section wall thickness and lengths of said elliptical outer profile major and minor axis lengths; said longitudinal inner profile circular radius (bore) terminating at said first cross-section proximity preferably being a full radius to minimize stress concentrations; said inner profile open end being closed by a closure tapered plug having a 3 to 5 degree taper and beam taper for said tapered plug closure of opening; said tapered plug being bonded or fused in place. Said tapered plug having a closure depth ratio; said depth ratio to be 35% to 50% the width of said tapered plug.

5. A geometric convex-segmented cross-section outer profile, being a convex-segment profile having 3 intersecting radius arc segments forming said profile comprising; a first arc radius at each end of a major axis length; a second arc radius at each end of a minor axis length; a first arc center on said major axis providing each first arc radius center; a second arc center on said minor axis length providing second arc center; a third arc radius located between and intersecting said first and second arc radii; said third arc radius center being located by two construction lines each projected from first and second arc end each extending through first and second arc center; said construction lines terminating at said third arc radius center intersection, providing the constructed center for third arc radius intersecting at first and second arcs; said third arc intersecting first and second arcs at each profile arc intersections, completing said convex-segmented 3-arc means for profile construction.

6. The connecting rod of claim 1, further including connecting rod bearing cap member including alignment sleeves machined onto the bearing cap surface, said alignment sleeves being raised machined circular elements on the mating surface of the bearing cap fitting into matching receiving alignment receptacles machined into the upper half of the connecting rod crankshaft journal body, alignment sleeves and through bolts being located on coincident axis, thereto secure assembly with bolt connections.

7. The connecting rod of claim 1, wherein said hollow connecting rod beam member having a tube member positioned on said connecting rod axis for the purpose of transferring oil from the crankshaft to the piston pin bearing surface, said tube member being fitted and secured to a receiving receptacle at the piston pin boss, the cavity sealing plug being fitted with an O-Ring packings to accept and seal the opposite end of the tube member at the crankshaft bearing end, thereby providing for axial motion differential between members.
